(19) United States
(12) Patent Application Publication
(10) Pub. No.: US 2020/0131999 A1
(43) Pub. Date: Apr. 30, 2020

(54) AIRFLOW CONTROL VALVE STRUCTURE

(71) Applicant: AISIN SEIKI KABUSHIKI KAISHA, Kariya-shi, Aichi-ken (JP)

(72) Inventors: Tomohiro YAMAGUCHI, Toyota-shi, Aichi-ken (JP); Hiromitsu ISHIHARA, Okazaki-shi, Aichi-ken (JP); Kyohei NINOMIYA, Kariya-shi, Aichi-ken (JP)

(73) Assignee: AISIN SEIKI KABUSHIKI KAISHA, Kariya-shi, Aichi-ken (JP)

(21) Appl. No.: 16/311,021

(22) PCT Filed: Mar. 28, 2017
(86) PCT No.: PCT/JP2017/012753

§ 371 Date: Dec. 18, 2018

(30) Foreign Application Priority Data
Jun. 23, 2016 (JP) 2016-124974

(51) Int. Cl. F02D 9/10; F16K 35/00

(52) U.S. Cl. CPC F02D 9/1095; F02M 35/104; F16K 35/00

(57) ABSTRACT

An airflow control valve structure includes a metal connecting shaft and a plastic valve body. The connection shaft includes an embedded portion. The connecting shaft is configured to rotate about a rotation axis. The embedded portion is embedded so that the valve body rotates integrally with the connecting shaft. The airflow control valve structure further includes a rotation restriction portion and a movement restriction portion. The rotation restriction portion is located on the embedded portion and restricts rotation of the embedded portion relative to the valve body. The movement restriction portion is located on the embedded portion and restricts movement of the embedded portion relative to the valve body in a direction along the rotation axis.

### TECHNICAL FIELD

The present invention relates to an airflow control valve structure, in particular, to an airflow control valve structure including a valve body that controls the flow of air supplied to a combustion chamber of an internal combustion engine.

### BACKGROUND ART

Patent Document 1 discloses an example of a conventional airflow control valve structure. In the airflow control valve structure, a metal connecting shaft (coupling shaft) having a rectangular cross section is press-fitted to a plastic end shaft part formed on a valve body to integrally couple the valve body and the connecting shaft to each other. This causes the valve body to rotate around its rotation axis integrally with the connecting shaft.

### PRIOR ART DOCUMENT

### Patent Document

Patent Document 1: Japanese Laid-Open Patent Publication No. 2015-1196

### SUMMARY OF THE INVENTION

### Problems that are to be Solved by the Invention

However, such an airflow control valve structure deteriorates due to the use or deteriorates over time, causing the plastics to be thermally or plastically deformed. This is likely to cause angle deviation (displacement in the circumferential direction) between the valve body and the connecting shaft and displacement in a direction along the rotation axis.

It is an object of the present invention to provide an airflow control valve structure that reduces angle deviation between a valve body and a connecting shaft and displacement in a direction along a rotation axis.

### Means for Solving the Problem

An airflow control valve structure includes a metal connecting shaft and a plastic valve body. The connection shaft includes an embedded portion. The connecting shaft is configured to rotate about a rotation axis. The embedded portion is embedded so that the valve body rotates integrally with the connecting shaft. The valve body is configured to open and close part of a cross-sectional flow area of an intake passage. The airflow control valve structure includes a rotation restriction portion and a movement restriction portion. The rotation restriction portion is located on the embedded portion. The rotation restriction portion restricts rotation of the embedded portion relative to the valve body. The movement restriction portion is located on the embedded portion. The movement restriction portion restricts movement of the embedded portion relative to the valve body in a direction along the rotation axis.

### BRIEF DESCRIPTION OF THE DRAWINGS

FIG. 1 is an exploded perspective view showing an airflow control valve structure according to a first embodiment.

FIG. 2 is a cross-sectional view showing the airflow control valve structure of FIG. 1.

FIG. 3A is a partial cross-sectional view showing the connection structure of a connecting shaft and a valve body in the airflow control valve structure of FIG. 1.

FIG. 3B is a cross-sectional view taken along line 3B-3B in FIG. 3A.

FIG. 4A is a partial front view showing the connecting shaft of FIG. 3A.

FIG. 4B is a side view showing the connecting shaft of FIG. 4A.

FIG. 5 is an exploded perspective view showing an airflow control valve structure according to a second embodiment.

FIG. 6A is a partial front view showing a connecting shaft of FIG. 5.

FIG. 6B is a side view showing the connecting shaft of FIG. 6A.

FIG. 7A is an exploded perspective view showing an airflow control valve structure according to a third embodiment.

FIG. 7B is a side view showing the connecting shaft of FIG. 7A.

### MODES FOR CARRYING OUT THE INVENTION

### First Embodiment

An airflow control valve structure according to a first embodiment will now be described.

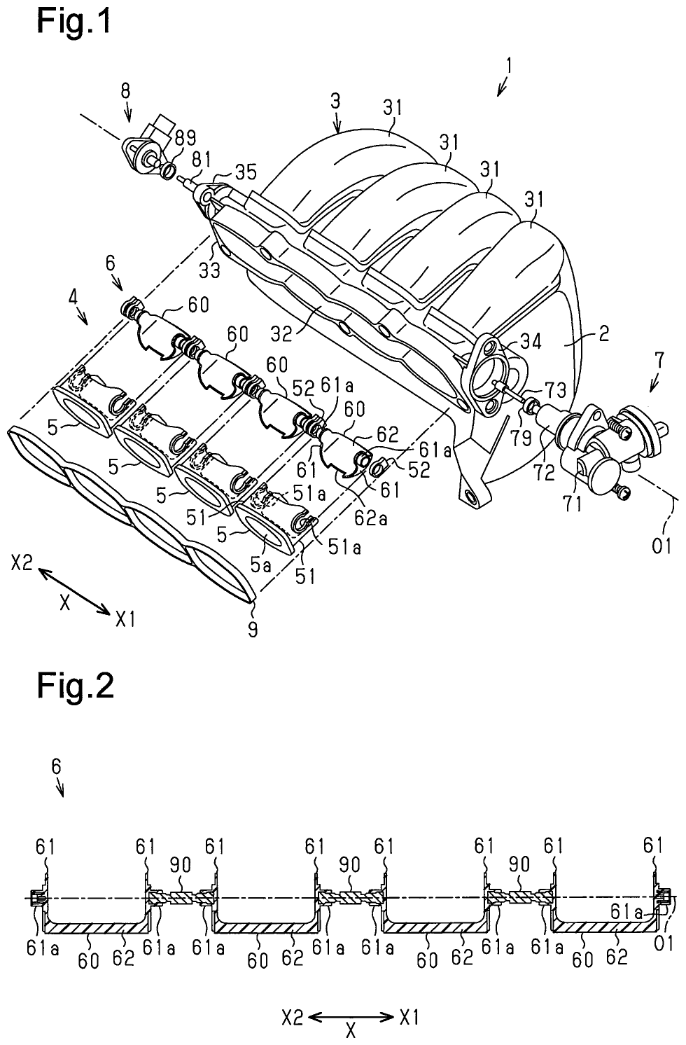

Referring to FIG. 1, an inline-four engine for a vehicle includes an intake device 1. The intake device 1 mixes air drawn from the outside with fuel supplied from the injector. Then, when the intake valve is opened in the intake stroke of the engine, the intake device 1 supplies the mixture obtained through the mixing to the combustion chamber. The engine compresses the mixture in the combustion chamber and ignites the compressed mixture to burn the mixture. The engine transfers the expansion force resulting from the burning from the piston to the crankshaft. In this manner, the drive force of the engine is extracted from the crankshaft.

The intake device 1 includes a surge tank 2 and a plastic intake manifold 3. The intake manifold 3 defines a plurality of (four) intake passages 31 extending so as to branch from the outlet of the surge tank 2. In the following description, the direction in which the intake passages 31 are laid out is referred to as the X-direction. One side and the other side in the X-direction (right side and left side in FIG. 1) are referred to as the X1-side and the X2-side, respectively.

The outlets of the intake passages 31 are surrounded by a tubular peripheral wall 32. The peripheral wall 32 includes an opening end 33 coupled to a cylinder head (not shown). The opening end 33 includes a groove (not shown) to which a gasket 9 is fitted.

Further, the intake device 1 includes an intake control valve 4 located in the vicinity of the outlet of the intake manifold 3.

The intake control valve 4 includes a plurality of (four) holders 5 that are substantially tubular. The holders 5 are fitted onto the inner wall surface of the peripheral wall 32 in correspondence with the intake passages 31. The holders 5 each include an opening 5a having a predetermined opening area (cross-sectional flow area). The holders 5 include two walls 51 opposed to each other in the X-direction. Each of the two walls 51 includes a supporting groove 51a that is substantially U-shaped. The supporting grooves 51a open toward the intake passages 31 and open in the X-direction.

Further, the intake control valve 4 includes an intake control valve body 6. The intake control valve body 6 includes a plurality of (four) valve bodies 60 laid out in the X-direction.

Each valve body 60 integrally includes two side walls 61 and a flat valve part 62. The two side walls 61 are opposed to the two walls 51 of the corresponding holder 5, respectively. The valve part 62 connects the ends of the two side walls 61 to each other in the X-direction. The valve part 62 is partially cut out to define a control passage 62a.

The two side walls 61 of each valve body 60 form shaft parts 61a. The shaft parts 61a are substantially boss-shaped and protrude toward the opposite sides along the X-direction. Each shaft part 61a is inserted through a bearing 52 that is substantially keyhole-shaped and opens in the X-direction. The bearings 52 are fitted into the supporting grooves 51a of the holders 5 to support the shaft parts 61a in cooperation with the holders 5. That is, each valve body 60 is supported by the corresponding holder 5 and the two bearings 52 and is rotational about the axis extending along the X-direction.

As shown in FIG. 2, the intake control valve body 6 includes a plurality of (three) metal connecting shafts 90. Each metal connecting shaft 90 connects adjacent ones of the valve bodies 60 in the X-direction. That is, each connecting shaft 90 is securely fixed to the shaft parts 61a of adjacent ones of the valve bodies 60 at the two ends of the connecting shaft 90. Thus, the valve bodies 60 all integrally rotate about the axis extending along the X-direction (hereinafter referred to as a rotation axis O1).

When each valve part 62 is in a rotation position of falling along the inner wall surface of the corresponding opening 5a so as to open the opening 5a, the valve body 60 is in an open state in which the opening 5a has a maximum opening area. When each valve part 62 is in a rotation position of rising along the inner wall surface of the corresponding opening 5a so as to close part of the opening 5a, the valve body 60 is in a limiting state in which the opening 5a has a minimum opening area.

As shown in FIG. 1, a first coupled part 34 is formed in the vicinity of the outlet on the X1-side of the intake manifold 3. An electric actuator 7 is attached to the first coupled part 34.

The electric actuator 7 includes a motor 71, a drive gear 72, and a metal rotation shaft 73. The drive gear 72 is coupled to the motor 71 in a driven manner so that the drive gear 72 rotates about the rotation axis O1. The rotation shaft 73 is concentric with the rotation axis O1 and is substantially columnar. The rotation shaft 73 is coupled to the drive gear 72 at the end of the X1-side to rotate integrally. The end of the rotation shaft 73 on the X2-side extends through the first coupled part 34 and is connected to its adjacent valve body 60, that is, to the intake control valve body 6 so as to rotate integrally. In other words, rotation of the drive gear 72 about the rotation axis O1 causes the rotation shaft 73 and the intake control valve body 6 to rotate integrally.

A mechanical locking part (not shown) is provided between the drive gear 72 and the intake manifold 3. The mechanical lock restricts rotation of the drive gear 72 when the rotation phase position of the drive gear 72 reaches a predetermined initial phase position, which is, for example, a phase position corresponding to the open state of the valve body 60. The rotation shaft 73 is inserted through an annular seal 79 located between the rotation shaft 73 and the first coupled part 34. The seal 79 limits leakage of air in the intake passages 31 toward the outside from between the first coupled part 34 and the rotation shaft 73.

A second coupled part 35 is formed in the vicinity of the outlet of the intake manifold 3 on the X2-side. A sensor unit 8 is attached to the second coupled part 35.

The sensor unit 8 includes a metal rotation shaft 81. In the same manner as the rotation shaft 73, the rotation shaft 81 is concentric with the rotation axis O1 and is substantially columnar. The end of the rotation shaft 81 on the X1-side extends through the second coupled part 35 and is connected to its adjacent valve body 60, that is, to the intake control valve body 6 so as to integrally rotate. In other words, rotation of the intake control valve body 6 about the rotation axis O1 causes the rotation shaft 81 to rotate integrally with the intake control valve body 6. The sensor unit 8 is configured to detect the rotation position of the rotation shaft 81, that is, open degree information of the intake control valve body 6. In the same manner as the rotation shaft 73, the rotation shaft 81 is inserted through an annular seal 89 located between the rotation shaft 81 and the second coupled part 35.

As described above, the intake device 1 is configured so that the two rotation shafts 73 and 81 and the intake control valve body 6 integrally rotate about the rotation axis O1. The electric actuator 7 is driven and controlled by an electronic controller (not shown). The electronic controller drives and controls the electric actuator 7 in order to control the position of the intake control valve body 6 based on the information retrieved from an activation map depending on the rotation speed and load of the engine. The electronic controller performs feedback control on driving of the electric actuator 7 based on the open degree information of the intake control valve body 6, which is detected by the sensor unit 8.

The connection structure of each connecting shaft 90 and its adjacent valve bodies 60 will now be described. In each valve body 60, the two side walls 61, the valve part 62, and the shaft parts 61a are integrally made of plastic.

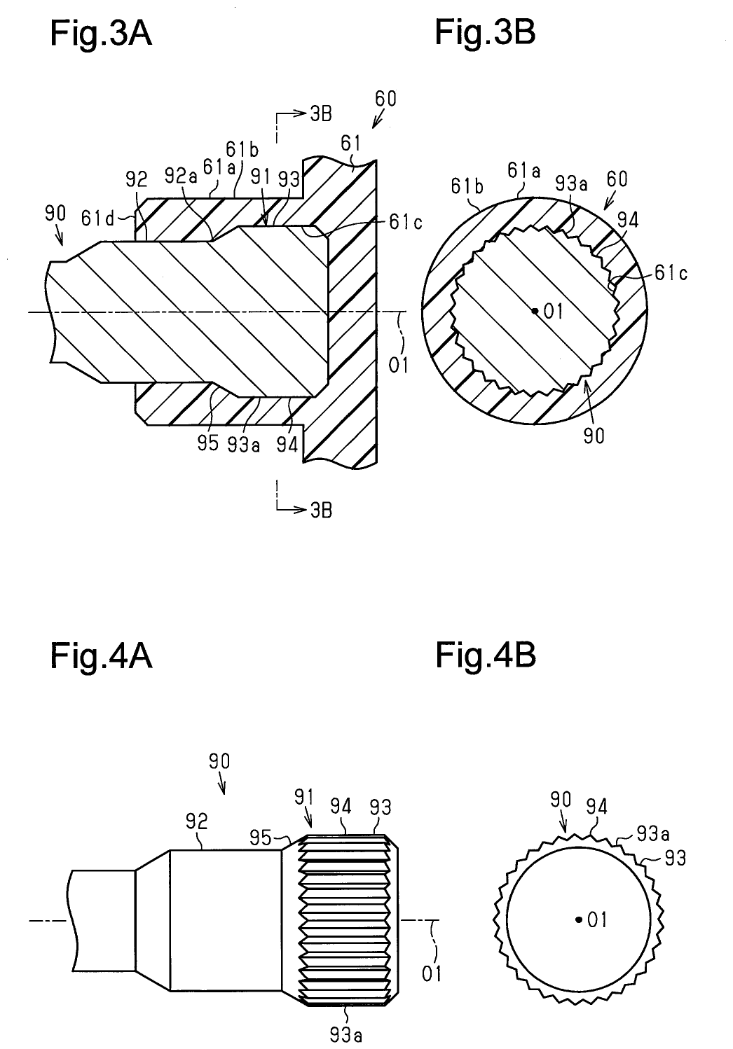

As shown in FIGS. 3A and 3B, in the valve body 60, the shaft part 61a of the side wall 61 opposed to the connecting shaft 90 is connected to the connecting shaft 90. The shaft part 61a includes an outer circumferential surface 61b that is concentric with the rotation axis O1 and is substantially circular.

The connecting shaft 90 is substantially columnar and includes a step that is concentric with the rotation axis O1. The connecting shaft 90 includes two ends 91 that are embedded in the shaft part 61a through, for example, insert-molding. Each end 91 of the connecting shaft 90 is in close contact with an inner wall surface 61c of the shaft part 61a over the entire length of the end 91. The end 91 configures an embedded portion.

Each end 91 includes a small-diameter part 92 and a large-diameter part 93 that are concentric with the rotation axis O1 and substantially columnar. That is, the small-diameter part 92 and the large-diameter part 93 have a center axis extending in the direction along the rotation axis O1. The large-diameter part 93 is connected to an end 92a of the two ends of the small-diameter part 92 that is located close to the side wall 61 (valve body 60). The large-diameter part 93 has a larger diameter than the small-diameter part 92. A tapered step 95 serving as a movement restriction portion is formed between the small-diameter part 92 and the large-diameter part 93 in the direction of the rotation axis O1. The intermediate part located between the two ends 91 of the connecting shaft 90 is exposed from an end surface 61d serving as a parting section of the plastic of the shaft part 61a.

As shown in FIGS. 4A and 4B, the large-diameter part 93 includes an outer circumferential surface 93a provided with an uneven portion 94 serving as a rotation restriction portion. The uneven portion 94 is uneven in the radial direction about the rotation axis O1 and includes recesses and the projections alternately arranged at equiangular intervals (cyclically). The recess-projection height (depth) of the uneven portion 94 is set to be substantially fixed over its entire length in the circumferential direction about the rotation axis O1. In addition, the uneven portion 94 extends with a substantially uniform cross section over the entire length of the large-diameter part 93 along the rotation axis O1. That is, the uneven portion 94 has a straight knurl shape.

Thus, the end 91 is meshed with the shaft part 61a at the uneven portion 94 and the step 95.

The operation and advantages of the present embodiment will now be described.

(1) In the present embodiment, each connecting shaft 90 includes the end 91 (embedded portion), which is embedded in the shaft part 61a (valve body 60). Further, the uneven portion 94 and the step 95 of the end 91 limit rotation (angle deviation) of the connecting shaft 90 relative to the valve body 60 and displacement of the connecting shaft 90 relative to the valve body 60 in the direction along the rotation axis O1.

(2) In the present embodiment, the uneven portion 94, which is uneven in the radial direction about the rotation axis O1, causes the end 91 to mesh with the plastic valve body 60. Thus, rotation of the connecting shaft 90 relative to the valve body 60 can be restricted with an extremely simple structure. Further, since the recesses and projections of the uneven portion 94 are cyclically arranged, stress occurs evenly in plastics flowing into the uneven portion 94. This further ensures that rotation of the connecting shaft 90 relative to the valve body 60 is restricted.

(3) In the present embodiment, each end 91 includes the step 95, which is located between the small-diameter part 92 and the large-diameter part 93 in the direction of the rotation axis O1, and is meshed with the plastic valve body 60 at the small-diameter part 92 and the large-diameter part 93, between which the step 95 is located. Thus, displacement of the connecting shaft 90 relative to the valve body 60 in the direction along the rotation axis O1 can be restricted with an extremely simple structure.

(4) In the present embodiment, the uneven portion 94 extends along the rotation axis O1 over the entire length of the large-diameter part 93. This increases the contact area between the valve body 60 and the uneven portion 94 (end 91). Increases in the contact area further ensure that rotation of the connecting shaft 90 relative to the valve body 60 is restricted.

(5) Connecting a metal connecting shaft and a plastic valve body (shaft part) through press-fitting or the like deforms the outer circumferential surface of the shaft part. This is likely to increase the sliding resistance when the valve body rotates. In the present embodiment, the shaft part 61a is integrated with the plastic valve body 60 with the end 91 (uneven portion 94 and step 95) embedded in the shaft part 61a. That is, insert-molding is employed to shape the outer circumferential surface 61b, which is substantially circular, while connecting the shaft part 61a (valve body 60) to the connecting shaft 90. Thus, the shape of the outer circumferential surface 61b is determined at the completion of connecting of the connecting shaft 90 and the valve body 60. This limits increases in the sliding resistance when the valve body 60 rotates.

(6) In the present embodiment, when the plastic of which the shaft part 61a (valve body 60) is made flows into the uneven portion 94, the contact area between the shaft part 61a and the end 91 increases. This further increases the torsional rigidity of the valve body 60.

(7) In the present embodiment, restricting rotation of the connecting shaft 90 relative to the valve body 60 reduces deviation of the rotation phase position (open degree), for example, between cylinders. This limits increases in the pressure loss and decreases in the performance of controlling air flow that would result from the deviation.

(8) In the present embodiment, restricting displacement of the connecting shaft 90 relative to the valve body 60 in the direction along the rotation axis O1 limits, for example, decreases or loss of the clearance in the direction along the rotation axis O1 between the valve body 60 and the holder 5. This limits increases in the sliding resistance when the valve body 60 rotates.

### Second Embodiment

An airflow control valve structure according to a second embodiment will now be described. In the second embodiment, the connection structure of the connecting shaft and the valve body of the first embodiment is changed. Thus, similar portions will not be described in detail. In the second embodiment, the structures having the same functions as the first embodiment are assigned with reference numerals of which the numbers less than or equal to the tens' place are identical to the first embodiment.

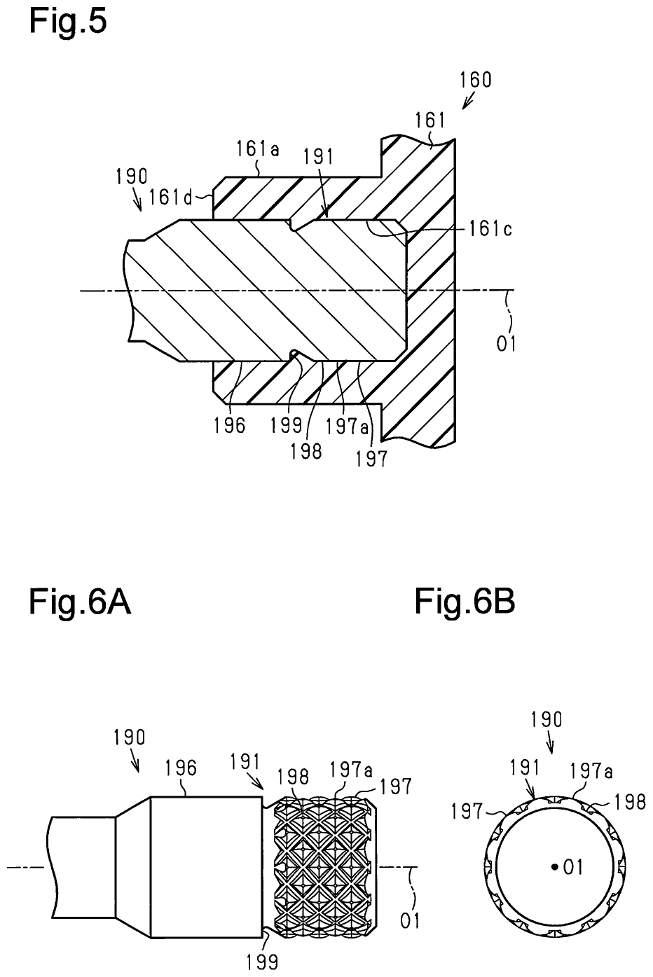

As shown in FIG. 5, an end 191 of a connecting shaft 190 is in close contact with an inner wall surface 161c of a shaft part 161a over the entire length of the end 191. The end 191 includes a first shaft 196 and a second shaft 197 that are concentric with the rotation axis O1 and substantially columnar. That is, the center axis of the first shaft 196 and the second shaft 197 extends in the direction along the rotation axis O1. The second shaft 197 is connected to one of the two ends of the first shaft 196 that is located closer to a side wall 161 (valve body 160). The first shaft 196 and the second shaft 197 have the same diameter. A circumferential groove 199 is recessed toward the rotation axis O1 in the radial direction between the first shaft 196 and the second shaft 197 in the direction of the rotation axis O1. The circumferential groove 199 is substantially annular and serves as a movement restriction portion. The intermediate part located between the two ends 191 of the connecting shaft 190 is exposed from an end surface 161d serving as a boundary of the plastic of the shaft part 161a.

As shown in FIGS. 6A and 6B, the second shaft 197 includes an outer circumferential surface 197a. The outer circumferential surface 197a includes a grid recess 198 engraved in a grid pattern (cross pattern or diamond pattern). The grid recess 198 serves as a rotation restriction portion and a movement restriction portion. In the grid recess 198, first grooves having a first predetermined angle with respect to the rotation axis O1 and second grooves having a second predetermined angle, which differs from the first predetermined angle, with respect to the rotation axis O1 intersect with each other (in other words, the grid recess 198 has a knurl shape).

Thus, the end 191 is meshed with the shaft part 161a at the grid recess 198 and the circumferential groove 199.

As detailed above, the second embodiment has the following advantage in addition to the same advantages as advantages (1) and (5) to (8) of the first embodiment.

(1) In the first embodiment, the end 91 of the connecting shaft 90 includes the large-diameter part 93, which has a larger diameter than the small-diameter part 92, to form the step 95 serving as a movement restriction portion. In the second embodiment, the end 191 of the connecting shaft 190 includes the grid recess 198, which serves as a rotation restriction portion and a movement restriction portion. Thus, the first shaft 196 and the second shaft 197 have the same outer diameter.

### Third Embodiment

An airflow control valve structure according to a third embodiment will now be described. In the third embodiment, the connection structure of the connecting shaft and the valve body of the first embodiment is changed. Thus, similar portions will not be described in detail. In the third embodiment, the structures having the same functions as the first embodiment are assigned with reference numerals of which the numbers less than or equal to the tens' place are identical to the first embodiment.

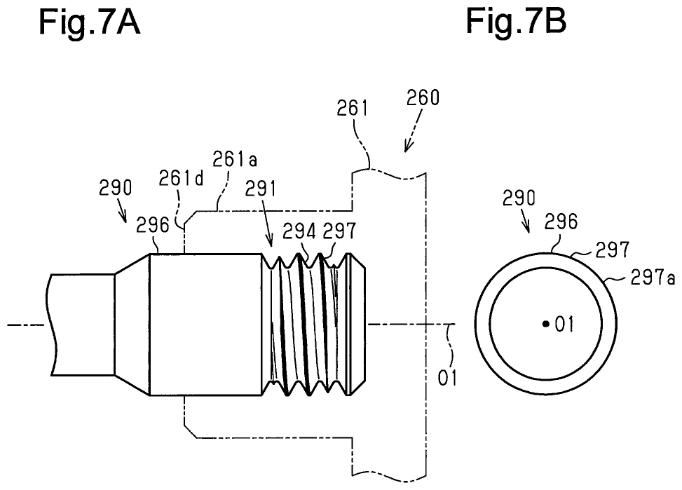

As shown in FIGS. 7A and 7B, an end 291 of a connecting shaft 290 is in close contact with an inner wall surface of a shaft part 261a over the entire length of the end 291. The end 291 includes a first shaft 296 and a second shaft 297 that are concentric with the rotation axis O1 and substantially columnar. That is, the center axis of the first shaft 296 and the second shaft 297 extends in the direction along the rotation axis O1. The second shaft 297 is connected to one of the two ends of the first shaft 296 that is located closer to a side wall 261 (valve body 260). The second shaft 297 substantially has the shape of an external thread. The outer diameter of the first shaft 296 and the outer diameter (crest diameter) of the second shaft 297 are the same. The intermediate part located between the two ends 291 of the connecting shaft 290 is exposed from an end surface 261d serving as a boundary of the plastic of the shaft part 261a.

The second shaft 297 includes an outer circumferential surface 297a. The outer circumferential surface 297a includes a helical uneven portion 294 that extends helically and is uneven in the radial direction about the rotation axis O1. Thus, the end 291 is meshed with the shaft part 261a at the helical uneven portion 294.

As detailed above, the third embodiment has the following advantage in addition to the same advantages as advantages (1) and (5) to (8) of the first embodiment and advantage (1) of the second embodiment.

The above-described embodiments may be modified as follows.

In the first embodiment, the uneven portion 94 does not have to be formed over the entire length of the large-diameter part 93.

In the first embodiment, the uneven portion 94 needs at least one pair of recess and projection.

In the first embodiment, the step 95 does not have to be tapered. That is, the step 95 may be formed in a stepped manner rising in a direction that is orthogonal to the rotation axis O1.

In the first embodiment, a flange protruding toward the radially outer side may be provided instead of the step 95.

In the first embodiment, the end 91 including the small-diameter part 92 and the large-diameter part 93 does not have to be employed. Instead, an end that has the shape of a circular truncated cone may be employed. The end gradually decreases in diameter as the valve body 60 becomes farther, that is, decreases in diameter toward the center of the connecting shaft 90 in the axial direction. In this case, an uneven portion having the same structure as the uneven portion 94 of the first embodiment simply needs to be formed on the outer circumferential surface of the end, which has the shape of a circular truncated cone.

In the first embodiment, a circumferential groove may be formed at any position of the large-diameter part 93 in the axial direction.

In the first embodiment, the uneven portion 94 does not have to be configured so that the recesses and the projections are alternately arranged at equiangular intervals. That is, the uneven portion may be configured so that recesses and projections are arranged in the circumferential direction intermittently and non-cyclically. Alternatively, instead of the uneven portion 94, an outer circumferential surface that is oval or substantially polygonal may be employed. Further, a flat surface parallel to the rotation axis may be formed on part of the outer circumferential surface of the end.

The second embodiment needs at least one first groove and one second groove, which form the grid recess 198 and intersect with each other.

In the second embodiment, a grid projection that projects toward the radially outer side may be formed instead of the grid recess 198.

In the second embodiment, the circumferential groove 199 may be formed at any position on the first shaft 196 and the second shaft 197 in the axial direction.

In the second embodiment, a flange protruding toward the radially outer side may be provided instead of the circumferential groove 199.

In the second embodiment, the circumferential groove 199 may be omitted.

In the third embodiment, the uneven portion 294 needs at least one turn of a helix.

In the second and third embodiments, the first shafts 196 and 296 and the second shafts 197 and 297 may have different outer diameters. For example, the second shafts 197 and 297 may have smaller outer diameters than respective first shafts 196 and 296.

In the second and third embodiments, the outer diameters of the second shafts 197 and 297 may gradually decrease as the valve bodies 160 and 260 become farther away, that is, gradually decrease toward the first shafts 196, 296.

In the second and third embodiments, the first shafts 196, 296 may be omitted.

In the first to third embodiments, the connection structures of the connecting shafts 90, 190, and 290 and the valve bodies 60, 160, and 260 may be applied to the connection structure of the rotation shaft 73, 81 and the valve body 60.

In the first to third embodiments, the airflow controlled by using the valve body 60 may be a tumble flow or a swirling flow in a cylinder.

1. An airflow control valve structure comprising:
a metal connecting shaft including an embedded portion, wherein the connecting shaft is configured to rotate about a rotation axis;
a plastic valve body in which the embedded portion is embedded so that the valve body rotates integrally with the connecting shaft, wherein the valve body is configured to open and close part of a cross-sectional flow area of an intake passage;
a rotation restriction portion located on the embedded portion, wherein the rotation restriction portion restricts rotation of the embedded portion relative to the valve body; and
a movement restriction portion located on the embedded portion, wherein the movement restriction portion restricts movement of the embedded portion relative to the valve body in a direction along the rotation axis.

2. The airflow control valve structure according to claim 1, wherein the rotation restriction portion includes an uneven portion that is uneven in a radial direction about the rotation axis.

3. The airflow control valve structure according to claim 2, wherein
the embedded portion includes a small-diameter part and a large-diameter part that have a center axis extending in the direction along the rotation axis, wherein the large-diameter part has a larger diameter than the small-diameter part and is connected to the small-diameter part, and
the movement restriction portion includes a step formed between the small-diameter part and the large-diameter part.

4. The airflow control valve structure according to claim 3, wherein the uneven portion extends along the rotation axis over an entire length of the large-diameter part.

5. The airflow control valve structure according to claim 1, wherein the rotation restriction portion and the movement restriction portion include a grid recess engraved in a grid pattern on an outer circumferential surface of the connecting shaft.

6. The airflow control valve structure according to claim 1, wherein
the rotation restriction portion and the movement restriction portion include a helical uneven portion formed on an outer circumferential surface of the embedded portion, and
the helical uneven portion extends helically and is uneven in a radial direction about the rotation axis.
